(19) United States
(12) Patent Application Publication
(10) Pub. No.: US 2022/0048721 A1
(43) Pub. Date: Feb. 17, 2022

(54) POST-PROCESSING DEVICE AND IMAGE FORMING APPARATUS

(71) Applicant: FUJIFILM Business Innovation Corp., Tokyo (JP)

(72) Inventors: Yoshiji KANO, Kanagawa (JP); Shinya TAKAHASHI, Kanagawa (JP); Tomoko TAGUCHI, Kanagawa (JP); Masaaki TAKAHASHI, Kanagawa (JP); Hiroshi ASHIZAWA, Kanagawa (JP)

(73) Assignee: FUJIFILM Business Innovation Corp., Tokyo (JP)

(21) Appl. No.: 17/148,529

(22) Filed: Jan. 13, 2021

(30) Foreign Application Priority Data
Aug. 14, 2020 (JP) 2020-137074

(51) Int. Cl. B65H 29/24; B65H 29/14

(52) U.S. Cl. CPC B65H 29/246; B65H 2301/131; B65H 2515/212; B65H 29/14

(57) ABSTRACT

A post-processing device includes an output unit that outputs a medium; a stacking unit on which the medium that is output is stacked; and a blow-out unit that is disposed below the output unit and that blows gas toward the medium that is output, wherein an amount of the gas blown varies in a width direction that crosses a direction in which the medium is output.

### CROSS-REFERENCE TO RELATED APPLICATIONS

This application is based on and claims priority under 35 USC 119 from Japanese Patent Application No. 2020-137074 filed Aug. 14, 2020.

### BACKGROUND

### (i) Technical Field

The present disclosure relates to a post-processing device and an image forming apparatus.

### (ii) Related Art

Japanese Unexamined Patent Application Publication No. 2016-52941 ([0031] to [0045], FIGS. 2 to 5) describes a known technique for blowing gas toward a medium discharged from an image forming apparatus.

According to Japanese Unexamined Patent Application Publication No. 2016-52941, a sheet (S) that has passed through a fixing device and whose temperature has been increased is cooled by a suction fan (4) disposed in the image forming apparatus, and is then cooled by gas blown from above the sheet (S) by a cooling unit (11) disposed outside the image forming apparatus.

### SUMMARY

Aspects of non-limiting embodiments of the present disclosure relate to a reduction of improper stacking of a medium on a stacking unit compared to when gas is blown against the medium uniformly in the width direction.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a post-processing device including an output unit that outputs a medium; a stacking unit on which the medium that is output is stacked; and a blow-out unit that is disposed below the output unit and that blows gas toward the medium that is output, wherein an amount of the gas blown varies in a width direction that crosses a direction in which the medium is output.

### BRIEF DESCRIPTION OF THE DRAWINGS

Exemplary embodiments of the present disclosure will be described in detail based on the following figures, wherein:

FIG. 1 illustrates the overall structure of an image forming apparatus according to a first exemplary embodiment;

FIG. 2 is a side view of a portion of a post-processing device including an output exit according to the first exemplary embodiment;

FIG. 3 is a perspective view of a relevant part of the post-processing device including the output exit according to the first exemplary embodiment;

FIGS. 4A to 4C illustrate blowing settings according to the first exemplary embodiment, wherein FIG. 4A illustrates a case where the flow volume is large in a central region, FIG. 4B illustrates a case where the flow volume is large in end regions, and FIG. 4C illustrates a case where the flow volume is large in a front end region (one end region);

FIGS. 5A and 5B illustrate the manner in which a medium is output by a structure according to the related art, wherein FIG. 5A illustrates a state in which the leading end of the medium has come into contact with an output tray, and FIG. 5B illustrates a state in which the medium is further output from the state illustrated in FIG. 5A; and

FIGS. 6A and 6B illustrate a second exemplary embodiment, wherein FIG. 6A illustrates a state in which a shutter is removed and FIG. 6B illustrates a state in which the shutter is attached.

### DETAILED DESCRIPTION

Exemplary embodiments of the present disclosure will now be described with reference to the drawings. However, the present disclosure is not limited to the exemplary embodiments described below.

To facilitate understanding of the following description, in each figure, the front-back direction (medium width direction), the left-right direction (medium transporting direction), and the up-down direction are defined as the X-axis direction, the Y-axis direction, and the Z-axis direction, respectively. In addition, the directions shown by arrows X, −X, Y, −Y, Z, and −Z are defined as forward, backward, rightward, leftward, upward, and downward, respectively, and sides in those directions are defined as the front side, the back side, the right side, the left side, the top side, and the bottom side, respectively.

In addition, in each figure, a circle with a dot in the middle shows the direction coming out of the page, and a circle with an X in the middle shows the direction going into the page.

In the drawings, components other than those to be described with reference to the drawings are omitted as appropriate to facilitate understanding.

### First Exemplary Embodiment

Description of Overall Structure of Printer U of First Exemplary Embodiment

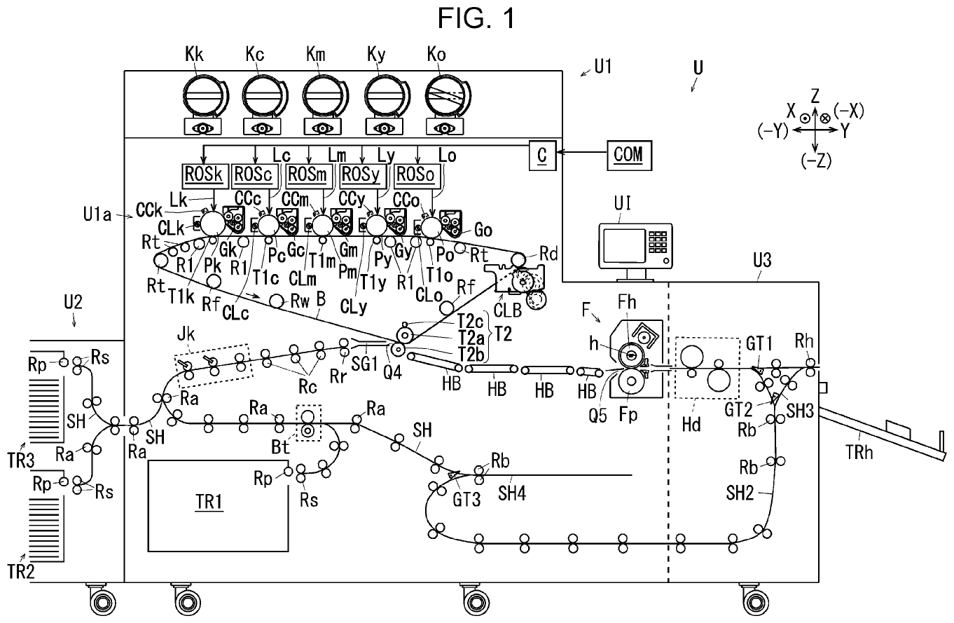

FIG. 1 illustrates the overall structure of an image forming apparatus according to a first exemplary embodiment.

Referring to FIG. 1, a printer U is an example of an image forming apparatus according to the first exemplary embodiment of the present disclosure. The printer U includes a printer body U1, a feeder unit U2, an operation unit UI, and a finisher U3. The feeder unit U2 is an example of a supply device that supplies a medium to the printer body U1. The operation unit UI is operated by a user. The finisher U3 is an example of a post-processing device that performs post-processing on the medium output from the printer body U1.

### Description of Marking Structure of First Exemplary Embodiment

Referring to FIG. 1, the printer body U1 includes a controller (example of a control unit) C, a communication unit (not illustrated), and a marking unit U1a. The controller C controls the printer U. The communication unit receives image information transmitted from a print image server COM, which is an example of an information transmission device connected to a unit outside the printer U by a dedicated cable (not illustrated). The marking unit U1a is an example of a recording unit that records an image on the medium. The print image server COM is connected to a personal computer PC by a line, such as a cable or a local area network (LAN). The personal computer PC is an example of an image transmission device that transmits information of an image to be printed by the printer U.

The marking unit U1a includes photoconductors Py, Pm, Pc, and Pk for respective colors, which are yellow (Y), magenta (M), cyan (C), and black (K), and a photoconductor Po used to make an image glossy when, for example, a photographic image is printed. The photoconductors Py to Po are examples of image carriers, and are each made of a dielectric having a photosensitive surface.

Referring to FIG. 1, a charging device CCk, an exposure device ROSk, a developing device Gk, a first transfer roller T1k, and a photoconductor cleaner CLk are arranged around the black photoconductor Pk in that order in a direction in which the photoconductor Pk rotates. The charging device CCk is an example of a charging unit. The exposure device ROSk is an example of a latent-image forming unit. The developing device Gk is an example of a developing unit. The first transfer roller T1k is an example of a first transfer unit. The photoconductor cleaner CLk is an example of an image-carrier cleaning unit.

Similarly, charging devices CCy, CCm, CCc, and CCo, exposure devices ROSy, ROSm, ROSc, and ROSo, developing devices Gy, Gm, Gc, and Go, first transfer rollers T1y, T1m, T1c, and T1o, and photoconductor cleaners CLy, CLm, CLc, and CLo are disposed around the other photoconductors Py, Pm, Pc, and Po.

Toner cartridges Ky, Km, Kc, Kk, and Ko, which are examples of developer containers, are removably supported above the marking unit U1a. Developers to be supplied to the developing devices Gy to Go are contained in the toner cartridges Ky to Ko.

An intermediate transfer belt B, which is an example of an intermediate transfer unit and which is also an example of an image carrier, is disposed below the photoconductors Py to Po. The intermediate transfer belt B is disposed between each of the photoconductors Py to Po and a corresponding one of the first transfer rollers T1y to T1o. The inner surface of the intermediate transfer belt B is supported by a driving roller Rd, a tension roller Rt, a walking roller Rw, plural idler rollers Rf, a backup roller T2a, plural retractable rollers R1, and the first transfer rollers T1y to T1o. The driving roller Rd is an example of a driving unit. The tension roller Rt is an example of a tension-applying unit. The walking roller Rw is an example of a meandering prevention unit. The idler rollers Rf are examples of driven units. The backup roller T2a is an example a second-transfer facing unit. The retractable rollers R1 are examples of movable units.

A belt cleaner CLB, which is an example of an intermediate-transfer-unit cleaning unit, is disposed on the outer surface of the intermediate transfer belt B at a position close to the driving roller Rd.

A second transfer roller T2b, which is an example of a second transfer member, faces the backup roller T2a with the intermediate transfer belt B disposed therebetween. A contact roller T2c, which is an example of a contact unit, is in contact with the backup roller T2a to apply a voltage of the same polarity as the charging polarity of the developers to the backup roller T2a.

The backup roller T2a, the second transfer roller T2b, and the contact roller T2c constitute a second transfer device T2, which is an example of a second transfer unit according to the first exemplary embodiment. The first transfer rollers T1y to T1o, the intermediate transfer belt B, the second transfer device T2, and other components constitute a transfer apparatus T1, B, T2, which is an example of a transfer unit according to the first exemplary embodiment.

A paper feed tray TR1, which is an example of a container, is provided below the second transfer device T2. Recording sheets S, which are examples of media, are stored in the paper feed tray TR1. A pick-up roller Rp, which is an example of a pick-up unit, and separation rollers Rs, which are examples of separation units, are disposed in an upper right region of the paper feed tray TR1. A transport path SH, along which the recording sheets S are transported, extends from the separation rollers Rs. Plural transport rollers Ra, which are examples of transport units that transport the recording sheets S downstream, are arranged along the transport path SH.

A deburring device Bt, which is an example of an unnecessary-portion-removing unit, is disposed downstream of the separation rollers Rs. The deburring device Bt performs deburring, which is a process of removing unnecessary portions at the edges of each recording sheet S by transporting the recording sheet S downstream while nipping the recording sheet S at a preset pressure.

A double-feeding detection device Jk is disposed downstream of the deburring device Bt. The double-feeding detection device Jk measures the thickness of the recording sheets S that pass therethrough to detect double feeding, which is a state in which multiple recording sheets S are transported in an overlapping state.

Correction rollers Rc, which are examples of position correction units, are disposed downstream of the double-feeding detection device Jk. The correction rollers Rc correct a skew, that is, an inclination of each recording sheet S with respect to the transporting direction.

Registration rollers Rr, which are examples of adjustment units that adjust the time at which each recording sheet S is transported to the second transfer device T2, are disposed downstream of the correction rollers Rc. A sheet guide SG1, which is an example of a medium guide unit, is disposed downstream of the registration rollers Rr.

The feeder unit U2 also includes paper feed trays TR2 and TR3 and other components that are structured similarly to the paper feed tray TR1, the pick-up roller Rp, the separation rollers Rs, and the transport rollers Ra. A transport path SH that extends from the paper feed trays TR2 and TR3 joins the transport path SH in the printer body U1 at a position upstream of the double-feeding detection device Jk.

Plural transport belts HB, which are examples of medium transport units, are disposed downstream of the second transfer roller T2b in the transporting direction of the recording sheet S.

A fixing device F, which is an example of a fixing unit, is disposed downstream of the transport belts HB in the transporting direction of the recording sheet S.

A decurler Hd, which is an example of a curvature-reducing unit, is disposed in the finisher U3, which is located downstream of the fixing device F. The decurler Hd reduces the curvature, or curl, of the recording sheet S by applying a pressure to the recording sheet S.

A transport path SH that extends toward an output tray TRh, which is an example of a stacking unit, is provided downstream of the decurler Hd. Output rollers Rh, which are examples of output units, are disposed at the downstream end of the transport path SH.

A reversing path SH2, which is an example of a transport path that branches from the transport path SH, is provided downstream of the decurler Hd. A first gate GT1, which is an example of a transporting-direction-switching unit, is disposed at the branching point at which the reversing path SH2 branches from the transport path SH.

The reversing path SH2 has plural switchback rollers Rb, which are examples of transport units that are rotatable in forward and reverse directions. A connection path SH3 is provided upstream of the switchback rollers Rb. The connection path SH3 is an example of a transport path that branches from an upstream portion of the reversing path SH2 and joins the transport path SH at a position downstream of the branching point at which the reversing path SH2 branches from the transport path SH. A second gate GT2, which is an example of a transporting-direction-switching unit, is disposed at the branching point at which the connection path SH3 branches from the reversing path SH2.

A switchback path SH4 is disposed downstream of the reversing path SH2 and below the fixing device F. The switchback path SH4 is used to reverse the transporting direction of the recording sheet S, that is, to transport the recording sheet S in a switchback manner. The switchback path SH4 has switchback rollers Rb, which are examples of transport units that are rotatable in forward and reverse directions. In addition, a third gate GT3, which is an example of a transporting-direction-switching unit, is disposed is at the entrance of the switchback path SH4.

A transport path SH disposed downstream of the switchback path SH4 joins the transport path SH that extends from the paper feed tray TR1.

### Marking Operation

The printer U starts a job, which is an image forming operation, when the printer U receives image information transmitted from the personal computer PC through the print image server COM. When the job is started, the photoconductors Py to Po, the intermediate transfer belt B, and other components rotate.

The photoconductors Py to Po are driven by a drive source (not illustrated).

The charging devices CCy to CCo receive a preset voltage and charge the surfaces of the respective photoconductors Py to Po.

The exposure devices ROSy to ROSo respectively output laser beams Ly, Lm, Lc, Lk, and Lo, which are examples of light beams for writing latent images, in accordance with control signals from the controller C, thereby writing electrostatic latent images on the charged surfaces of the photoconductors Py to Po.

The developing devices Gy to Go develop the electrostatic latent images on the surfaces of the respective photoconductors Py to Po into visible images.

The toner cartridges Ky to Ko supply the developers to the respective developing devices Gy to Go, which consume the developers in the developing process.

The first transfer rollers T1y to T1o receive a first transfer voltage having a polarity opposite to the charging polarity of the developers, so that the visible images on the surfaces of the photoconductors Py to Po are transferred onto the intermediate transfer belt B.

The photoconductor cleaners CLy to CLo clean the surfaces of the respective photoconductors Py to Po by removing the developers that remain on the surfaces of the photoconductors Py to Po after the first transfer process.

The intermediate transfer belt B passes through first transfer regions, in which the intermediate transfer belt B faces the photoconductors Py to Po. At this time, O, Y, M, C, and K images are transferred onto the intermediate transfer belt B in that order. Then, the intermediate transfer belt B passes through a second transfer region Q4, in which the intermediate transfer belt B faces the second transfer device T2. In a case where a monochrome image is formed, an image of a single color is transferred onto the intermediate transfer belt B and transported toward the second transfer region Q4.

The recording sheets S are fed from one of the paper feed trays TR1 to TR3 by the corresponding pick-up roller Rp in accordance with, for example, the size of the received image information, designation of the recording sheets S, and the sizes and types of the recording sheets S that are stored.

The separation rollers Rs separate the recording sheets S fed by the pick-up roller Rp from each other.

The deburring device Bt applies a preset pressure to each recording sheet S that passes therethrough to deburr the recording sheet S.

The double-feeding detection device Jk detects the thickness of the recording sheets S that pass therethrough to detect double feeding of the recording sheets S.

The correction rollers Rc correct a skew of each recording sheet S that passes therethrough by bringing the recording sheet S into contact with a wall surface (not illustrated).

The registration rollers Rr feed the recording sheet S in accordance with the time when the images on the surface of the intermediate transfer belt B reach the second transfer region Q4.

The sheet guide SG1 guides the recording sheet S fed by the registration rollers Rr to the second transfer region Q4.

The backup roller T2a of the second transfer device T2 receives a preset second transfer voltage having the same polarity as the charging polarity of the developers through the contact roller T2c, so that the images on the intermediate transfer belt B are transferred onto the recording sheet S.

The belt cleaner CLB cleans the intermediate transfer belt B by removing the developers that remain on the surface of the intermediate transfer belt B after the images are transferred in the second transfer region Q4.

The transport belts HB hold the recording sheet S to which the images have been transferred by the second transfer device T2 on the surfaces thereof, and transport the recording sheet S downstream.

The fixing device F includes a heating roller Fh, which is an example of a heating member, and a pressing roller Fp, which is an example of a pressing member. A heater h, which is an example of a heat source, is disposed in the heating roller Fh. The fixing device F heats the recording sheet S that passes through a fixing region Q5, in which the heating roller Fh and the pressing roller Fp are in contact with each other, while pressing the recording sheet S, thereby fixing the unfixed images on the surface of the recording sheet S to the recording sheet S. The heating roller Fh and the pressing roller Fp constitute a fixing member Fp, Fh according to the first exemplary embodiment.

The decurler Hd applies a pressure to the recording sheet S that has passed through the fixing device F to remove the curvature, or curl, of the recording sheet S.

When the recording sheet S that has passed through the decurler Hd is to be subjected to double-sided printing, the first gate GT1 is activated so that the recording sheet S is transported to the reversing path SH2, transported in a switchback manner along the switchback path SH4, and then fed to the registration rollers Rr again along the transport path SH. Then, printing is performed on a second surface of the recording sheet S.

When the recording sheet S is to be output onto the output tray TRh face-up, that is, such that the surface on which an image is recorded faces upward, the recording sheet S is transported along the transport path SH and output onto the output tray TRh by the output rollers Rh.

When the recording sheet S is to be output face-down, that is, such that the surface on which the image is recorded faces downward, the recording sheet S is temporarily transported from the transport path SH to the reversing path SH2. After the trailing end of the recording sheet S in the transporting direction has passed the second gate GT2, forward rotation of the switchback rollers Rb is stopped. Then, the second gate GT2 is switched and the switchback rollers Rb are rotated in the reverse direction so that the recording sheet S is transported to the output tray TRh along the connection path SH3. The output recording sheet S is placed on the output tray TRh.

### Description of Blowing Mechanism

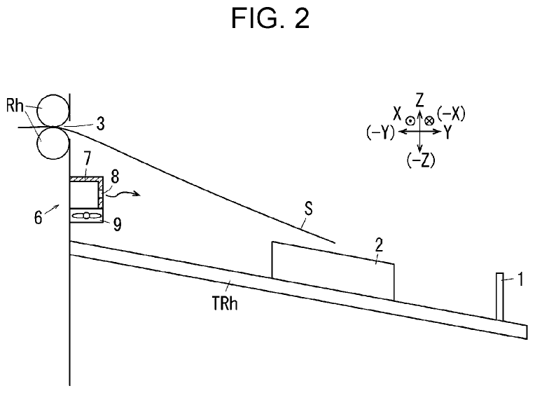

FIG. 2 is a side view of a portion of the post-processing device including an output exit according to the first exemplary embodiment.

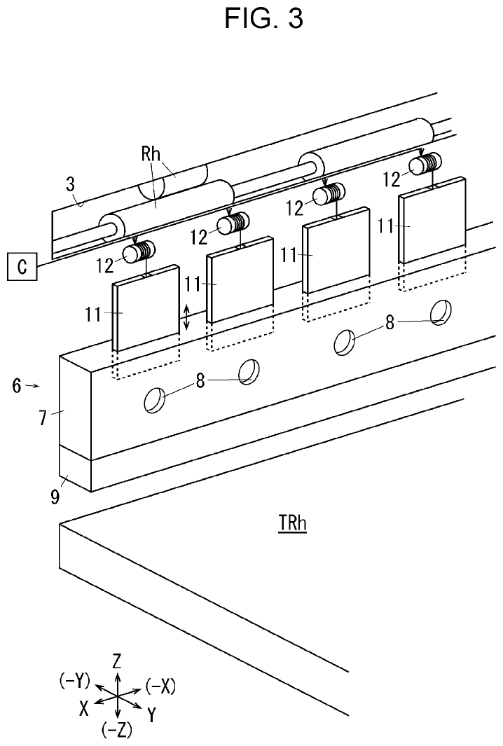

FIG. 3 is a perspective view of a relevant part of the post-processing device including the output exit according to the first exemplary embodiment.

Referring to FIGS. 1 to 3, in the first exemplary embodiment, the output tray TRh is inclined downstream in the sheet transporting direction and downward in the direction of gravity. The output tray TRh includes an end guide 1, which is an example of a stopper unit, at the downstream end thereof in the direction of gravity. The output tray TRh also includes a side guide 2, which is also an example of a stopper unit, at a deep side (back side) thereof, which is an example of the other side in a width direction.

A blowing device 6, which is an example of a blow-out unit, is disposed below an output exit 3 through which the sheet S output by the output rollers Rh passes. The blowing device 6 includes a housing 7. The housing 7 according to the first exemplary embodiment has a hollow rectangular tubular shape that extends in the front-back direction, which is a width direction of the sheet S. The housing 7 has plural blow-out holes 8. The blow-out holes 8 are arranged with gaps therebetween in the width direction of the sheet S. In the first exemplary embodiment, for example, the blow-out holes 8 are arranged over a region extending to positions corresponding to both ends of widest paper that is usable.

A fan 9, which is an example of a gas transporting unit, is disposed below the housing 7. The fan 9 according to the first exemplary embodiment sucks outside air into the housing 7. Accordingly, the gas that has been sucked into the housing 7 is blown out through the blow-out holes 8.

Shutters 11, which are examples of covers, are disposed in an upper region of the housing 7. The shutters 11 are arranged to correspond to respective ones of the blow-out holes 8. The shutters 11 according to the first exemplary embodiment are suspended by wires that extend from winding devices 12, which are examples of moving units. The winding devices 12 are controlled based on control signals from the controller C. In the first exemplary embodiment, each winding device 12 unwinds the wire to lower the corresponding shutter 11 by gravity to a covering position, at which the shutter 11 covers the corresponding blow-out hole 8. The winding device 12 wind the wire to move the corresponding shutter 11 upward to an uncovering position, at which the shutter 11 uncovers the corresponding blow-out hole 8.

Although the winding devices 12 are described as examples of the structures for moving the shutters 11, the structures for moving the shutters 11 are not limited to this. For example, solenoids may be used as drive sources for moving the shutters 11, and the shutters 11 may be moved by turning on and off the solenoids. Alternatively, the shutters 11 may be moved by using motors, which are examples of drive sources, and rack-and-pinion units, which are examples of transmission mechanisms. Alternatively, the shutters 11 may be moved hydraulically or pneumatically.

The direction in which the shutters 11 are moved is not limited to the up-down direction, and may be any direction, such as the width direction.

Although each of the blow-out holes 8 may be provided with one shutter 11, shutters that are each capable of covering two or more of the blow-out holes 8 at the same time may instead be used when the number of blow-out holes 8 is large.

The controller C according to the first exemplary embodiment includes an input/output interface I/O through which signals are input and output from/to an external device. The controller C also includes a read-only memory (ROM) in which programs, information, etc. used to perform necessary processes are stored. The controller C also includes a random-access memory (RAM) that temporarily stores necessary data. The controller C also includes a central processing unit (CPU) that performs processes in accordance with the programs stored in, for example, the ROM. Thus, the controller C according to the first exemplary embodiment is composed of a microcomputer. The controller C provides various functions by executing the programs stored in, for example, the ROM.

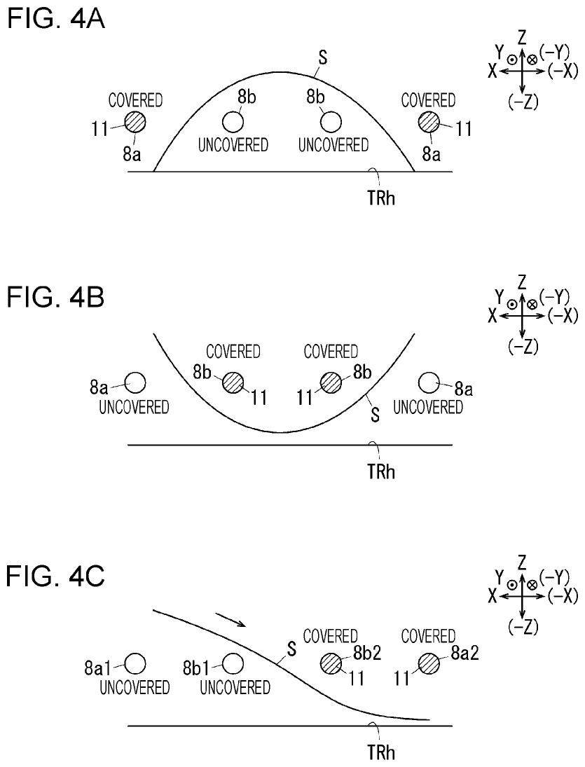

FIGS. 4A to 4C illustrate blowing settings according to the first exemplary embodiment, wherein FIG. 4A illustrates a case where the flow volume is large in a central region, FIG. 4B illustrates a case where the flow volume is large in end regions, and FIG. 4C illustrates a case where the flow volume is large in a front end region (one end region).

The controller C according to the first exemplary embodiment controls the shutters 11 so that the shutters 11 are moved to the covering position in a range in the width direction in which the flow volume, which is the amount of gas blown from the blow-out holes 8, is to be reduced. Referring to FIGS. 4A to 4C, the controller C according to the first exemplary embodiment covers some of the blow-out holes 8 with the corresponding shutters 11 to bend the medium that is output. Referring to FIG. 4A, to bend the medium convexly as viewed in an output direction in which the medium is output, the blow-out holes 8 (8a) in the end regions in the width direction are covered and only the blow-out holes 8 (8b) in the central region are uncovered so that the flow volume is greater in the central region than in the end regions. Referring to FIG. 4B, to bend the medium concavely as viewed in the output direction, the blow-out holes 8 (8b) in the central region in the width direction are covered and only the blow-out holes 8 (8a) in the end regions are uncovered so that the flow volume is greater in the end regions than in the central region.

In addition, to move the sheet S on the output tray TRh in the width direction, the controller C according to the first exemplary embodiment operates so that the flow volume varies in the width direction depending on the direction in which the sheet S is to be moved. Referring to FIG. 4C, to move the sheet S toward the side guide 2 on the right side (back side of the finisher U3) as viewed in the output direction, the blow-out holes 8a1 and 8b1 at the front side (one side) are uncovered and the blow-out holes 8a2 and 8b2 at the back side (other side) are covered. Thus, the sheet S may be moved toward the back so that a side edge of the sheet S comes into contact with the side guide 2 and that the sheet S is aligned. To move the sheet S toward the front, the blow-out holes 8 to be covered and uncovered are switched.

The user may select one of the settings illustrated in FIGS. 4A to 4C through the operation unit UI.

### Operations of First Exemplary Embodiment

In the finisher U3 according to the first exemplary embodiment having the above-described structure, the flow volume of the gas blown against the sheet S output toward the output tray TRh varies in the width direction. Therefore, the sheet S is output to the output tray TRh while the sheet S is bent as illustrated in FIG. 4A or FIG. 4B or is raised at one side thereof. In particular, the leading end portion of the sheet S in the output direction is easily bent or raised at one side thereof. Therefore, when the leading end of the sheet S in the output direction comes into contact with the upper surface of the output tray TRh and the sheet S is placed on the output tray TRh, the contact area is less than when the sheet S comes into contact with the output tray TRh over the entire region thereof in the width direction. Accordingly, the frictional resistance of the sheet S is reduced.

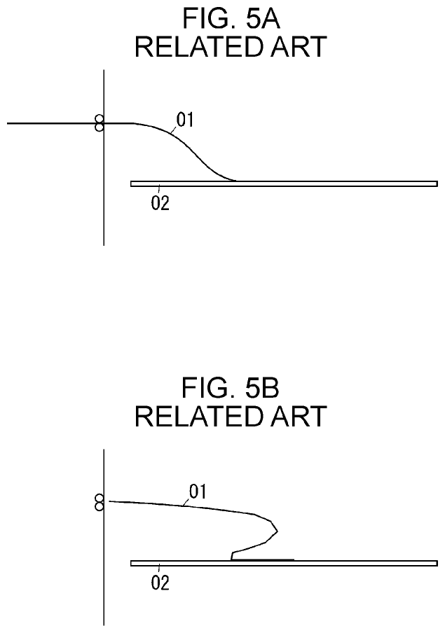

FIGS. 5A and 5B illustrate the manner in which a medium is output by a structure according to the related art, wherein FIG. 5A illustrates a state in which the leading end of the medium has come into contact with an output tray and FIG. 5B illustrates a state in which the medium is further output from the state illustrated in FIG. 5A.

Referring to FIGS. 5A and 5B, when no gas is blown against a sheet 01 as in the structure of the related art, the leading end of the sheet 01 in the transporting direction comes into contact with an output tray 02 over substantially the entire region thereof in the width direction, as illustrated in FIG. 5A. Here, the sheet 01 may be, for example, thin paper with low stiffness or coated paper having a large coefficient of friction with respect to the output tray. In such a case, when the sheet 01 is further transported, there is a risk that the frictional force between the sheet 01 and that the output tray 02 will exceed the stiffness of the sheet 01 and the sheet 01 will buckle instead of moving downstream, as illustrated in FIG. 5B. When the sheet 01 buckles, improper stacking may occur. More specifically, the sheet 01 may be bent, reversed upside down, or stacked in an incorrect order.

In contrast, according to the first exemplary embodiment, the flow volume of the gas blown against the sheet S varies in the width direction. Therefore, as illustrated in FIGS. 4A to 4C, the contact area in which the leading end portion of the sheet S in the transporting direction comes into contact with the output tray TRh is reduced. Accordingly, the frictional force between the leading end portion of the sheet S in the output direction and the output tray TRh is reduced. As a result, according to the first exemplary embodiment, the risk of buckling of the sheet S is less than that in the structure of the related art. Thus, according to the first exemplary embodiment, the occurrence of improper stacking may be reduced.

In addition, according to the first exemplary embodiment, when the sheet S is bent convexly as illustrated in FIG. 4A, the central region of the sheet S in the width direction does not easily come into contact with the surface of the output tray TRh. Therefore, the occurrence of abrasion marks on the sheet S may be reduced.

In addition, according to the first exemplary embodiment, when the sheet S is bent concavely as illustrated in FIG. 4B, forces in directions from both ends toward the center of the sheet S in the width direction are easily applied to the sheet S. Therefore, the sheet S does not easily move outward in the width direction, and linearity of movement of the sheet S may be increased.

In addition, when the sheet S is raised at one side thereof in the width direction as illustrated in FIG. 4C, the sheet S may be moved toward the side guide 2. Therefore, the level of alignment of the sheet S may be increased. The level of alignment may be further increased by installing a vibrating device that vibrates the output tray TRh.

### Second Exemplary Embodiment

A second exemplary embodiment according to the present disclosure will now be described. In the description of the second exemplary embodiment, components corresponding to those of the first exemplary embodiment are denoted by the same reference signs, and detailed description thereof is omitted.

The second exemplary embodiment has differences described below from the first exemplary embodiment, but is similar to the first exemplary embodiment in other respects.

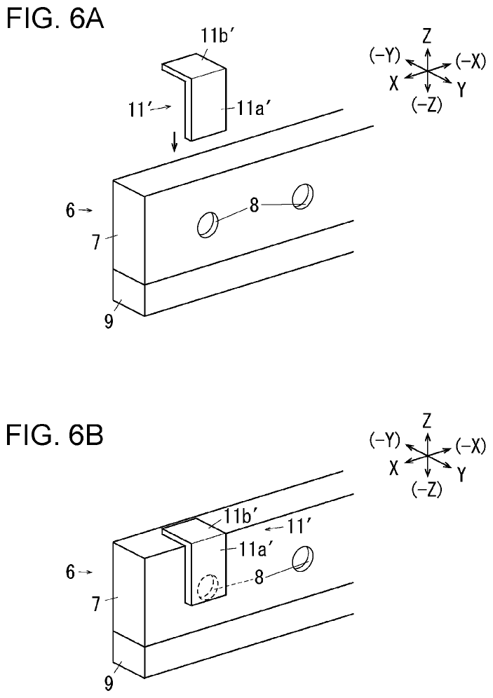

FIGS. 6A and 6B illustrate the second exemplary embodiment, wherein FIG. 6A illustrates a state in which a shutter is removed and FIG. 6B illustrates a state in which the shutter is attached.

Referring to FIGS. 6A and 6B, a blowing device 6 according to the second exemplary embodiment includes shutters 11′, which are examples of covers, in place of the shutters 11 and the winding devices 12 according to the first exemplary embodiment. Each of the shutters 11′ according to the second exemplary embodiment includes a body portion 11a′ and a fall prevention portion 11b′ that extends leftward from the top end of the body portion 11a′. The body portion 11a′ is plate-shaped, and is capable of facing and covering each of the blow-out holes 8

According to the second exemplary embodiment, each shutter 11′ is made of a magnet, and the housing 7 is made of iron, which is an example of a magnetic material. Therefore, the shutter 11′ may be attracted (attached) to the housing 7 by magnetic force. The shutter 11′ may also be manually pulled off from the housing 7 by a user. According to the second exemplary embodiment, the fall prevention portion 11b′ is plate-shaped and comes into contact with the top surface of the housing 7 to help prevent the shutter 11′ from falling.

### Effects of Second Exemplary Embodiment

According to the blowing device 6 of the second exemplary embodiment having the above-described structure, the shutter 11′ is attached to each of the blow-out holes 8 which the user intends to cover, and is not attached to (or is removed from) each of the blow-out holes 8 which the user intends to uncover, so that the flow volume differs in the width direction. According to the second exemplary embodiment, unlike the first exemplary embodiment, it is not necessary to provide moving units, such as the winding devices 12. Therefore, the manufacturing cost, the maintenance cost, etc. may be reduced.

### Modifications

Although exemplary embodiments of the present disclosure have been described in detail, the present disclosure is not limited to the above-described exemplary embodiments, and various modifications are possible within the gist of the present disclosure described in the claims. Modifications (H01) to (H010) of the present disclosure will now be described.

(H01) Although the printer U is described as an example of an image forming apparatus in the above-described exemplary embodiments, the image forming apparatus is not limited to this, and may instead be, for example, a copy machine, a facsimile machine, or a multifunction machine having some or all of the functions of these machines. Also, the image forming apparatus is not limited to an electrophotographic image forming apparatus, and may be any image forming apparatus, such as an inkjet or thermal transfer image forming apparatus.

(H02) Although the printer U uses developers of five colors in the above-described exemplary embodiment, the image forming apparatus is not limited to this, and may instead be, for example, a monochrome image forming apparatus or a multicolor image forming apparatus that uses four or less or six or more colors.

(H03) Although the endless band-shaped intermediate transfer belt B is described as an example of an image carrier in the above-described exemplary embodiments, the image carrier is not limited to this. The image carrier may instead be, for example, a cylindrical intermediate transfer drum, a photoconductor drum, or a photoconductor belt. Also, the intermediate transfer body may be omitted, and an image may be recorded on a sheet S directly from a photoconductor.

(H04) In the above-described exemplary embodiments, the number of blow-out holes 8 is not limited to the above-described number, and may be increased or reduced depending on, for example, the design or specifications. Although the blow-out holes 8 are arranged in the width direction in the above-described exemplary embodiments, the blow-out holes 8 may instead be disposed at different positions in the up-down direction or arranged in the up-down direction. When the blow-out holes 8 are disposed at upper and lower positions, the flow volumes in the central region and the end regions in the width direction may be set to different values by covering only the upper blow-out holes 8 and uncovering the lower blow-out holes 8 in the end regions in the width direction and uncovering both the upper and lower blow-out holes 8 in the central region in the width direction.

Alternatively, a single elongated or slit-shaped blow-out hole that extends in the width direction of the sheet S may be provided and covered with the shutters 11, 11′ in regions where the flow volume is to be reduced. In this case, the flow volume distribution may be more continuously (linearly) and finely adjusted compared to when the flow volume distribution is adjusted stepwise as in the first and second exemplary embodiments. The number of slit-shaped blow-out holes is not limited to one, and plural slit-shaped blow-out holes may be arranged with gaps therebetween in the width direction or the height direction. Thus, the shape of the blow-out holes 8 is not limited to a circular shape, and may instead be any shape, such as an elongated shape or a rectangular shape.

(H05) Although each of the blow-out holes 8 is completely covered or completely uncovered to vary the flow volume in the above-described exemplary embodiments, the configuration is not limited to this. For example, the degree to which each shutter 11 covers the corresponding blow-out hole 8 may be adjustable so that the opening area of the blow-out hole 8 may be adjusted to change the amount of gas blown. The flow volume may be more finely adjusted by adjusting the opening area.

(H06) In the above-described exemplary embodiments, the combinations of the blow-out holes 8 that are covered and the blow-out holes 8 that are uncovered are not limited to those illustrated in FIGS. 4A to 4C. For example, every other blow-out hole 8 in the width direction may be uncovered so that the sheet S is bent in a wave shape. When the sheet S is bent in this manner, linearity of movement of the sheet S may be improved. In the case where a large number of blow-out holes 8 are provided, the sheet S may be bent in a wave shape by periodically covering two blow-out holes 8 and uncovering two blow-out holes 8 in the width direction. Thus, the pattern in which the blow-out holes 8 are covered and uncovered may be changed as appropriate in accordance with the shape into which the sheet S is to be bent.

(H07) Although the shutters 11′ are attracted by magnetic force in the second exemplary embodiment, the shutters 11′ are not limited to this. Each shutter 11′ may instead be removably attached by a combination of a lug and a hole or by a fastener, such as a screw or a bolt. In addition, in the first exemplary embodiment, the winding devices 12 for the shutters 11 may be omitted, and the user may manually slide the shutters 11 to cover or uncover the blow-out holes 8.

(H08) Although the finisher U3 and the printer body U1 are separate components in the above-described exemplary embodiments, the finisher U3 and the printer body U1 may instead be integrated together. Alternatively, the blowing device 6 may be installed in an image forming apparatus to which the finisher U3 is not attached.

(H09) In the above-described exemplary embodiments, the shape of the housing 7 is not limited to a rectangular tubular shape, and may be any shape, such as a round tubular shape.

(H010) In the above-described exemplary embodiments, the blow-out holes 8 may be individually provided with fans, and the flow volume may be controlled by controlling the rotational speed of each fan so that the amount of gas blown varies in the width direction. It is not necessary that each blow-out hole 8 be provided with a dedicated fan, and one fan may be provided for each group of multiple blow-out holes 8 (for example, two or three blow-out holes 8).

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A post-processing device comprising:
an output unit that outputs a medium;
a stacking unit on which the medium that is output is stacked; and
a blow-out unit that is disposed below the output unit and that blows gas toward the medium that is output, wherein an amount of the gas blown varies in a width direction that crosses a direction in which the medium is output.

2. The post-processing device according to claim 1, wherein the blow-out unit is configured such that the amount of the gas blown varies in the width direction so that the medium that is output is bent as viewed in the direction in which the medium is output.

3. The post-processing device according to claim 2, wherein the amount of the gas blown is greater in a central region than in an end region in the width direction.

4. The post-processing device according to claim 2, wherein the amount of the gas blown is greater in an end region than in a central region in the width direction.

5. The post-processing device according to claim 1, wherein the blow-out unit is configured such that the amount of the gas blown varies in the width direction so that the medium is transported toward one side in the width direction.

6. The post-processing device according to claim 5, wherein the amount of the gas blown is greater at other side than at the one side in the width direction.

7. The post-processing device according to claim 1, wherein the blow-out unit has a plurality of blow-out holes that are arranged in the width direction and from which the gas is blown,
wherein the post-processing device further comprises a plurality of transporting units, each of which is disposed to correspond to one or more of the blow-out holes and transports the gas toward the one or more of the blow-out holes, and
wherein amounts of the gas transported by the transporting units differ so that the amount of the gas blown varies in the width direction.

8. The post-processing device according to claim 2, wherein the blow-out unit has a plurality of blow-out holes that are arranged in the width direction and from which the gas is blown,
wherein the post-processing device further comprises a plurality of transporting units, each of which is disposed to correspond to one or more of the blow-out holes and transports the gas toward the one or more of the blow-out holes, and
wherein amounts of the gas transported by the transporting units differ so that the amount of the gas blown varies in the width direction.

9. The post-processing device according to claim 3, wherein the blow-out unit has a plurality of blow-out holes that are arranged in the width direction and from which the gas is blown,
wherein the post-processing device further comprises a plurality of transporting units, each of which is disposed to correspond to one or more of the blow-out holes and transports the gas toward the one or more of the blow-out holes, and
wherein amounts of the gas transported by the transporting units differ so that the amount of the gas blown varies in the width direction.

10. The post-processing device according to claim 4, wherein the blow-out unit has a plurality of blow-out holes that are arranged in the width direction and from which the gas is blown,
wherein the post-processing device further comprises a plurality of transporting units, each of which is disposed to correspond to one or more of the blow-out holes and transports the gas toward the one or more of the blow-out holes, and
wherein amounts of the gas transported by the transporting units differ so that the amount of the gas blown varies in the width direction.

11. The post-processing device according to claim 5,
wherein the blow-out unit has a plurality of blow-out holes that are arranged in the width direction and from which the gas is blown,
wherein the post-processing device further comprises a plurality of transporting units, each of which is disposed to correspond to one or more of the blow-out holes and transports the gas toward the one or more of the blow-out holes, and
wherein amounts of the gas transported by the transporting units differ so that the amount of the gas blown varies in the width direction.

12. The post-processing device according to claim 6, wherein the blow-out unit has a plurality of blow-out holes that are arranged in the width direction and from which the gas is blown,
wherein the post-processing device further comprises a plurality of transporting units, each of which is disposed to correspond to one or more of the blow-out holes and transports the gas toward the one or more of the blow-out holes, and
wherein amounts of the gas transported by the transporting units differ so that the amount of the gas blown varies in the width direction.

13. The post-processing device according to claim 1,
wherein the blow-out unit has a plurality of blow-out holes that are arranged in the width direction and from which the gas is blown,
wherein the post-processing device further comprises a cover capable of covering and uncovering one or more of the blow-out holes, and
wherein the cover covers one or more of the blow-out holes so that the amount of the gas blown varies in the width direction.

14. The post-processing device according to claim 2, wherein the blow-out unit has a plurality of blow-out holes that are arranged in the width direction and from which the gas is blown,
wherein the post-processing device further comprises a cover capable of covering and uncovering one or more of the blow-out holes, and
wherein the cover covers one or more of the blow-out holes so that the amount of the gas blown varies in the width direction.

15. The post-processing device according to claim 3, wherein the blow-out unit has a plurality of blow-out holes that are arranged in the width direction and from which the gas is blown,
wherein the post-processing device further comprises a cover capable of covering and uncovering one or more of the blow-out holes, and
wherein the cover covers one or more of the blow-out holes so that the amount of the gas blown varies in the width direction.

16. The post-processing device according to claim 4, wherein the blow-out unit has a plurality of blow-out holes that are arranged in the width direction and from which the gas is blown,
wherein the post-processing device further comprises a cover capable of covering and uncovering one or more of the blow-out holes, and
wherein the cover covers one or more of the blow-out holes so that the amount of the gas blown varies in the width direction.

17. The post-processing device according to claim 13, further comprising:
a moving unit that moves the cover between an uncovering position at which the cover uncovers one or more of the blow-out holes and a covering position at which the cover covers one or more of the blow-out holes; and
a control unit that controls the moving unit to move the cover to the covering position in accordance with a range in the width direction in which the amount of the gas blown is to be reduced.

18. The post-processing device according to claim 13, wherein the cover is removably attachable to the blow-out unit, and
wherein the cover is attached to cover one or more of the blow-out holes in accordance with a range in the width direction in which the amount of the gas blown is to be reduced.

19. The post-processing device according to claim 18, wherein the cover is removably attachable to the blow-out unit by magnetic force.

20. An image forming apparatus comprising:
a recording unit that records an image on a medium;
an output unit that outputs the medium on which the image is recorded;
a stacking unit on which the medium that is output is stacked; and
a blow-out unit that is disposed below the output unit and that blows gas toward the medium that is output, wherein an amount of the gas blown varies in a width direction that crosses a direction in which the medium is output.
